(19) United States
(12) Patent Application Publication
(10) Pub. No.: US 2005/0153195 A1
(43) Pub. Date: Jul. 14, 2005

(54) Secondary battery

(76) Inventor: Kyu Nam Han, Suwon-si (KR)

Correspondence Address: CHRISTIE, PARKER & HALE, LLP, PO BOX 7068, PASADENA, CA, 91109-7068, US

(21) Appl. No.: 11/036,480

(22) Filed: Jan. 13, 2005

(30) Foreign Application Priority Data
Jan. 13, 2004 (KR) 2004-0002444
Jun. 21, 2004 (KR) 2004-00046272

(51) Int. Cl. H01M 2/04; H01M 2/30; H01M 2/34

(52) U.S. Cl. 429/59; 429/175; 429/178

(57) ABSTRACT

A secondary battery including a bare cell and a safety device coupled to the bare cell, wherein the secondary battery has a battery component part having a safety device such as a protective circuit board mounted in a plastic molding or an assembled casing. An exterior surface of the bare cell and an exterior surface of the battery component part has a coupling portion for coupling the exterior surface of the bare cell to the exterior surface of the battery component part. Additionally, the exterior surface of the bare cell and the exterior surface of the battery component part further includes a supplementary element for supplementing the coupling between both coupling portions.

### CROSS-REFERENCE TO RELATED APPLICATION

This application claims priority to and the benefit of Korean patent application 2004-0002444 filed in the Korean Intellectual Property Office on Jan. 13, 2004 and Korean patent application 2004-00046272 filed in the Korean Intellectual Property Office on June 21, 2004, the entire content of which is incorporated herein by reference.

### BACKGROUND OF THE INVENTION

1. Field of the invention

The present invention relates to a secondary battery, and more particularly to a secondary battery including a bare cell having an electrode assembly, a can and a cap assembly, and a protective circuit board electrically connected to the bare cell.

2. Description of the Prior Art

As generally known in the art, secondary batteries are rechargeable and may be made in a compact form with a large capacity. Such batteries have recently been broadly researched and developed. Typical examples of secondary batteries include nickel-metal hydride (Ni-MH) batteries, lithium (Li) batteries and lithium-ion (Li-ion) batteries.

In such secondary batteries, most bare cells are formed by inserting an electrode assembly composed of a positive electrode, a negative electrode, and a separator into a can formed of a metal such as aluminum or aluminum alloys, closing the can with a cap assembly, injecting an electrolyte into the can, and then sealing the can. Although the can may be formed of iron materials, a can formed of aluminum or aluminum alloys has certain advantages. Specifically, an aluminum battery may be lighter and may not corrode even after being used a long time under high voltage.

A battery is an energy source, and has the potential to discharge a large amount of energy. In the case of a secondary battery, high energy is stored in a charged state. Also, in a charging process of a secondary battery, an external energy source is needed to supply the energy to be stored in the battery. When an internal short circuit or other disorders of a secondary battery are generated during the above described process or state, the energy stored in the battery may be discharged in a short period of time, thereby causing safety problems such as fire, explosion, or the like.

Lithium secondary batteries, which are now increasingly being used, include lithium, a highly active element. Thus, lithium batteries have a greater potential for fire or explosion when they malfunction. In the case of a lithium ion battery, lithium exists not in a metal state but in an ion state, and thus the safety of the battery can be improved compared to a battery using lithium in the metal state. However, negative electrode materials and non-aqueous electrolytes, among others, still used in the battery are flammable, and thus lithium-ion batteries still have a great potential for fire or explosion when they malfunction.

Accordingly, a secondary battery is usually equipped with various safety devices for preventing fire or explosion caused by malfunction of the battery itself in a charged state or during the charging process. These safety devices are generally connected to a positive terminal and a negative terminal of a bare cell through a conductive structure such as a lead plate. These safety devices can interrupt electric current, for example, when a battery is heated to a high temperature or when a battery voltage rapidly increases due to, for example, overcharge or overdischarge, thereby preventing dangers such as explosion and/or firing of the battery. Typical examples of safety devices coupled with a bare cell include a protective circuit board that can detect abnormal electric current or voltage to interrupt electric current, a Positive Temperature Coefficient (PTC) device operated according to the occurrence of overheating due to abnormal electric current, and a bimetal device, among others.

A secondary battery having a bare cell coupled with a safety device is contained in a separate casing to provide a secondary battery having a finished outer appearance. Further, a bare cell and a safety device, such as a protective circuit board connected to the bare cell, are fixed to each other or are encapsulated with a plastic molding that fills in the gap between the bare cell and the protective circuit board, thereby providing a secondary battery having a finished appearance.

In general, secondary batteries have different constitutional materials, shapes, sizes, etc., depending on their production companies and product models, and the design of a suitable safety device is also varied according to such factors. Additionally, typical producers for secondary batteries provide batteries in the form of a package including a bare cell and a protective circuit board, etc., integrated into one body. In most cases, a secondary battery has a predetermined material and design so that the secondary battery forms a part of a product set to which it is mounted.

Under these circumstances, secondary batteries have no interchangeability among various products, and thus it is difficult for consumers to select a secondary battery for use in a desired product set. Therefore, even if one battery has the same operating conditions and functions as a second battery for the exclusive use of a desired product set, it is not possible to use the first battery in the product set instead of the specialized battery made for such exclusive use.

To solve this problem, a secondary battery that can be used in various product sets having the same battery operating conditions and functions has been developed. In order to accomplish this, a secondary battery is often provided as a pack-type secondary battery, in which the terminals of a bare cell and those of a safety device such as a protective circuit board are bonded by welding, and the space between the bare cell and the protective circuit board is filled with a plastic molding, thereby bonding the bare cell with the protective circuit physically.

FIG. 1 is a schematic exploded perspective view showing a conventional pack-type lithium-ion battery before coupling with a plastic molding. FIG. 2 is a perspective view showing a conventional plastic pack-type secondary battery, which has been coupled with a plastic molding.

Referring to FIGS. 1 and 2, in a pack-type battery, a protective circuit board 30 is disposed in parallel with the surface of a bare cell, on which electrode terminals 130, 111 are formed. Additionally, as shown in FIG. 2, a gap between the bare cell 100 and the protective circuit board is filled with a plastic molding. When the gap is filled with the plastic molding, the molding may cover even the exterior surface of the protective circuit board. However, external input/output terminals 31, 32 must be exposed to the exterior.

The bare cell 100 includes a positive terminal 111 and a negative terminal 130 on the surface facing the protective circuit board 30. The positive terminal 111 may be a cap plate, formed from aluminum or aluminum alloys, or a nickel-containing metal plate bonded to a cap plate. The negative terminal 130 is a terminal protruding from a cap plate, and is electrically isolated from the cap plate 110 by a peripheral insulator gasket (not shown).

The protective circuit board 30 includes a panel formed from a resin, on which a circuit is disposed, and on which the external I/O terminals 31, 32, are formed on the exterior surface thereof. The protective circuit board 30 has a dimension and a shape that are substantially the same as those of the surface (cap plate surface) of the bare cell facing thereto.

The internal surface of the protective circuit board 30, opposite to the surface having external terminals 31, 32 is equipped with a circuit section 35 and connection terminals 36, 37. The circuit section 35 may include, for example, a protective circuit for protecting a battery from overcharging/overdischarging during charging/discharging of the battery. The circuit section 35 and each external I/O terminal 31, 32 are electrically connected to each other by a conductive structure passing through the protective circuit board 30.

Connection leads 41, 42 and an insulating plate 43, etc., are disposed between the bare cell 100 and the protective circuit board 30. The connection leads 41, 42, generally formed of nickel, are used for making an electric connection between the cap plate 110 and each connection terminal 36, 37 of the protective circuit board 30. Also, they may have an “L”-shaped form or a planar structure. In order to make an electric connection between each connection lead 41,42 and respective terminal 36, 37, a resistance spot welding method may be used. In the embodiment as shown in FIG. 1, a separate breaker is formed in the connection lead 42 disposed between the protective circuit board and the negative terminal. In this case, the circuit section 35 of the protective circuit board has no breaker. The insulating plate 43 is disposed for the purpose of making electric insulation between the connection lead 42 connected to the negative terminal 130 and the cap plate as a positive terminal.

However, when the bare cell 100 and other battery components including the protective circuit board 30 are incorporated into a pack-type battery by using a plastic molding, problems may arise. For instance, since the plastic molding part 20 for securely coupling the protective circuit board 30 to the bare cell 100 is made of a material different than that of the bare cell 100, which includes metallic components such as the cap plate 110 and the can, and because it has a small contact area with the bare cell 100, the plastic molding part forms a weak bond with the bare cell.

To increase bonding strength between the plastic molding part 20 and the bare cell 100, the size of a connection structure such as a lead plate may be increased or a separate reinforcing structure may be formed. For example, an embodiment in which a separate reinforcing structure is welded to a cap plate with a space partially formed between the reinforcing structure and the bare cell so that the space may be filled with a plastic molding while the plastic molding covers the reinforcing structure may be considered. However, in order to form such a reinforcing structure, additional materials and welding processes are needed.

Additionally, in order to pour a resin for plastic molding between the bare cell and the protective circuit board and then cure it, a mold for plastic molding is needed. Further, the mold should be removed after use, thereby complicating the manufacturing process. Moreover, there is an additional problem which may arise if, when resin for the plastic molding is poured, the resin is not uniformly distributed in the gap between the protective circuit board and the bare cell. Specifically, when a reinforcing structure having a complicated structure is used, it is very difficult to fill the gap between the protective circuit board and the bare cell uniformly with the resin for plastic molding.

### SUMMARY OF THE INVENTION

Accordingly, the present invention provides a secondary battery formed in such a manner that a bare cell can be coupled with a safety device such as a protective circuit board, mechanically and electrically, in a stable and simple manner.

Additionally, a secondary battery having the problems of conventional pack-type batteries may be avoided. Such problems include the use of a complicated plastic molding process, not uniformly filling the gap between the protective circuit board and the bare cell with a resin for plastic molding, and having a weak bond between the protective circuit board and the bare cell.

The secondary battery provided includes a bare cell, and a safety device coupled to the bare cell. The secondary battery has a battery component part including a safety device such as a protective circuit board mounted in a plastic molding or an assembled casing while external input/output terminals are exposed to the exterior. Additionally each of the exterior surfaces of the bare cell and the battery component part, which are to be coupled to each other, have a coupling portion for coupling both surfaces. The battery further includes a supplementary element for easily and stably forming a mechanical or electrical linkage between both surfaces.

According to an embodiment of the present invention, at least a part of the coupling portion has a supplementary element for reinforcing electric connection, which has additional functions as an electrical connection by being electrically connected to an electric terminal of a safety device and to an electrode of a bare cell. For example, when the coupling portions are formed like a snap button, the supplementary element may be a conductive paste or a plating layer formed on the interface between the female receiver portion and the male insertion portion of the snap button to reinforce the electrical connection efficiency.

When a snap button or a lead plate is used as the coupling portion, the supplementary element may be a groove formed on the bottom surface of the battery component part, by which the coupling portions may be easily exposed to the exterior. In other words, when a groove is formed on the bottom surface of the plastic molding or assembled casing of the battery component part so as to expose the coupling portions to predetermined direction, the coupling portions may be easily exposed to the exterior through the groove. More particularly, when the coupling portions formed as a snap button or a lead plate are fastened or folded and are tightly fixed by welding, they may be exposed to the exterior through the groove, and thus may be easily welded, for example, by irradiating a laser beam through the groove.

In an exemplary embodiment of the present invention, wherein the coupling portions are formed as a snap button or a lead plate and then are welded, in order to facilitate the welding process, the battery component part may include coupling portions protruded from the bonding surface so that they can be exposed to the exterior even in 10 the absence of a groove after the mechanical coupling portions of the battery component part and the bare cell are folded or engaged. In this case, the coupling portions protruded between the bonding surfaces of the battery component part and the bare cell, when coupling portions of both surfaces are engaged, may cause the formation of a gap.

### BRIEF DESCRIPTION OF THE DRAWINGS

FIG. 1 is a schematic exploded perspective view showing a conventional pack-type lithium-ion battery before coupling with a plastic molding.

FIG. 2 is a perspective view showing a conventional pack-type lithium ion secondary battery which has been coupled with a plastic molding.

FIG. 3 is a sectional view showing the structure of a battery component part and an upper part of a bare cell according to one embodiment of the present invention.

FIGS. 4 to 6 are schematic partial front views showing the exterior appearances of secondary batteries according to exemplary embodiments of the present invention, wherein a battery component part and a bare cell are bonded by welding.

### DETAILED DESCRIPTION

Hereinafter, an exemplary embodiment of the present invention will be described with reference to the accompanying drawings. In the following description and drawings, the same reference numerals are used to designate the same or similar components, and so repetition of the description on the same or similar components will be omitted.

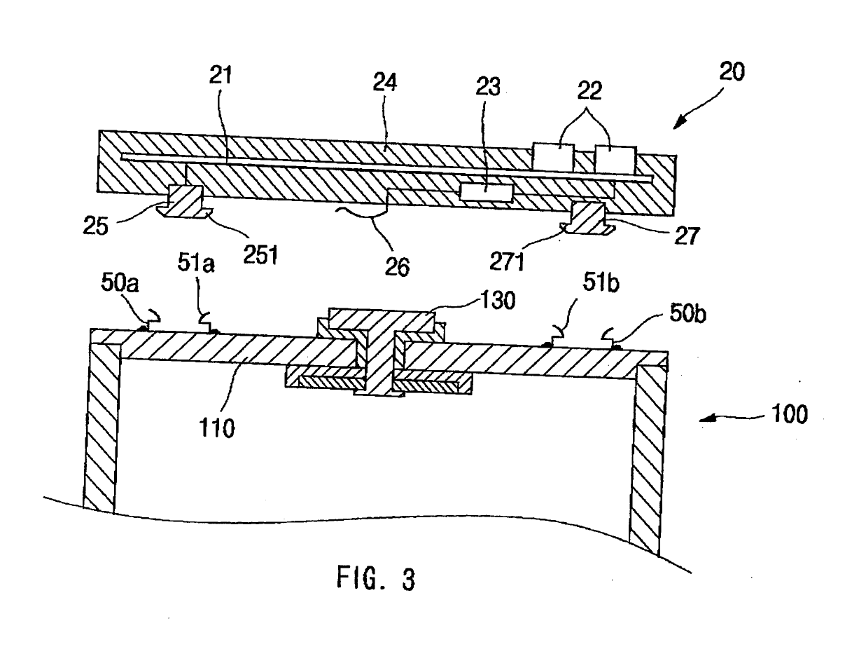

Referring to FIG. 3, a secondary battery includes a battery component part 20 and a bare cell 100. The battery component part 20 includes a protective circuit board 21 and a bimetal device 23 connected in series through electric terminals, the protective circuit board 21 and the bimetal device 23 being encapsulated by a plastic molding 24. When the battery component part 20 is manufactured by using a molding method according to the embodiment as shown in FIG. 3, it is convenient to produce and control a mold to be used with a large number of molding processes because the battery component part 20 is significantly smaller than the whole secondary battery including the bare cell 100. Additionally, there is no limitation regarding a safety valve (not shown) of a cap plate 110 in contrast with a conventional secondary battery obtained by pouring a resin for plastic molding between the protective circuit board and the bare cell. Further, the problem of a gap between the protective circuit board and the bare cell not being uniformly filled with a resin for plastic molding due to a modified structure of some components or addition of components for increasing the adhesion strength of the resin for plastic molding may be avoided.

According to the embodiment as shown in FIG. 3, the battery component part 20 uses a plastic resin molding. However, if desired, the battery component part 20 may form an assembly by using a resin and a metallic part in order to encapsulate the protective circuit board 21 and the bimetal device 23.

One terminal of the protective circuit board 21 and one terminal of the bimetal device 23, each not participating in the connection between the protective circuit board and the bimetal device, is connected with either a male mechanical coupling portion 25, 27 (male insertion portions of snap buttons), or with a negative electrode connection part 26, on the bottom surface of the battery component part 20. Therefore, the male mechanical coupling portion 25 connected to the terminal of the protective circuit board 21 may also function as an electric connection part.

The surface of the rectangular cap plate 110, generally being the smallest surface in the bare cell 100, has female mechanical coupling portions 50a, 50b (female receiver portions of snap buttons) at both sides of a longer lateral side, the female mechanical coupling portions 50a, 50b being mechanically coupled to the male mechanical coupling portions 25, 27, respectively, of the battery component part 20. The female mechanical coupling portion 50 may be bonded to the cap plate 110 by, for is example, a laser welding method, so as to maintain mechanical bonding strength. In the center of the cap plate 110, a negative terminal 130 of the bare cell 100 protrudes while being electrically insulated from the remaining parts of the bare cell.

Preferably, the male mechanical coupling portions 25, 27 are partially embedded in the plastic molding 24 of the battery component part 20 so that they are coupled to the battery component part 20 with significant mechanical strength. Each end of the male mechanical coupling portions 25, 27, to which the bare cell 100 is coupled, has a jaw 251, 271. Each of the female mechanical coupling portions 50a, 50b includes a sloped V-shaped neck 51a, 51b at the entrance thereof. When the male mechanical coupling portions 25, 27 are inserted into the female mechanical coupling portions 50a, 50b in order to couple the battery component part 20 with the bare cell 100, the V-shaped neck 51a, 50b widens elastically so that it may receive the jaws 251, 271. When the male mechanical coupling portions 25, 27 are forcibly removed, the V-shaped neck 51a, 51b having no sloped portion is engaged with the jaws 251, 271. Therefore, once the battery component part 20 is coupled with the bare cell 100, it is difficult to separate them from each other. Further, the male mechanical coupling portions 25, 27 and the female mechanical coupling portions 50a, 51b are fixed to the battery component part and the bare cell, respectively, with a significant strength. Therefore, each of the protective circuit board 21 and the bimetal device 23 in the battery component part 20 is stably coupled with the bare cell 100.

In the battery component part 20, a negative electrode connection part 26, to which one electric terminal of the bimetal device 23 is connected, is formed as a plate-shaped spring. When the mechanical coupling portions 25, 27, 50a, 50b of the battery component part 20 are bonded to the bare cell 100, the plate-shaped spring is in contact with the negative terminal 130 of the bare cell and causes deformation of the terminal, thereby maintaining the contact with the negative terminal 130 over a large area. The negative electrode may form a mechanical boding structure in the same manner as the positive electrode so as to prevent separation after bonding.

Generally, aluminum-containing metals have better conductivities than those of other metals. However, even if the coupling portions according to embodiments of the present invention are formed of aluminum-containing metals, a high electric resistance may result when the coupling portions are in superficial electric contact only. In other words, the contact resistance between the female mechanical coupling portions 50 and the male mechanical coupling portions 25 increases electrical resistance, thereby increasing the internal impedance of the battery. Such increased internal impedance may cause deterioration of the performance of a secondary battery. Additionally, when the mechanical coupling portions are in superficial electric contact only, electric contact between the coupling portions becomes unstable due to external impacts.

Therefore, according to the embodiment as shown in FIG. 3, the male mechanical coupling portion 25, 27 of the battery component part and the female mechanical coupling portion 50a, 50b of the bare cell 100 include a plating layer formed from a conductor, such as gold, or a coating layer formed from the paste of a conductor, such as silver paste, which are in contact when the male and female portions are coupled. In an exemplary embodiment, the plating layer or a paste coating layer is applied on bonding surfaces of the female mechanical coupling portion 50a, 50b and the male mechanical coupling portion 25, 27.

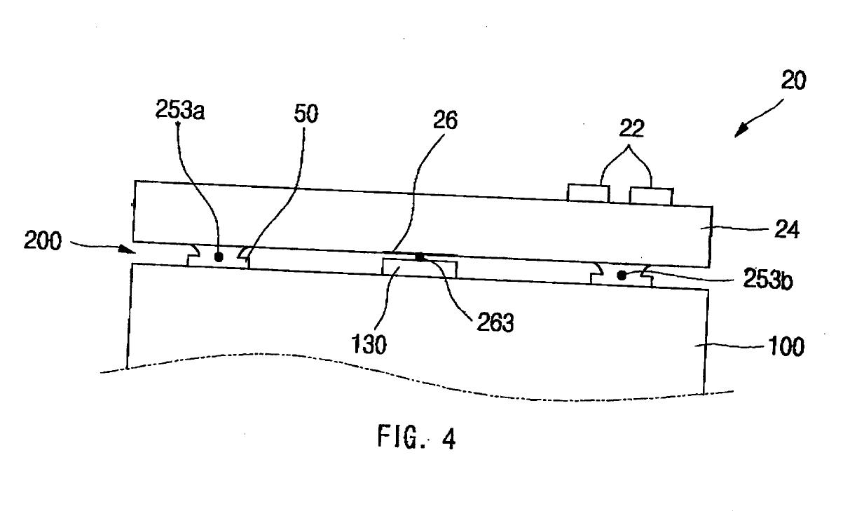

FIGS. 4 to 6 are schematic front views showing the partial exterior appearances of secondary batteries according to other exemplary embodiments of the present invention, wherein a battery component part 20 and a bare cell 100 are bonded by welding. These embodiments are based on a supplementary element for facilitating and reinforcing a mechanical linkage rather than an electrical supplementary element for reducing the contact resistance at the bonding point between the bare cell 100 and the battery component part 20.

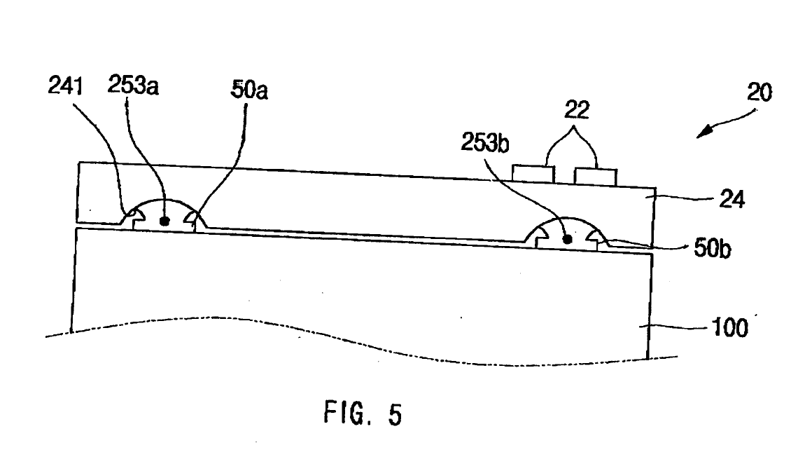

It should be understood that the structure of the coupled battery component part 20 and bare cell 100 is substantially the same as that of the embodiment as shown in FIG. 3. Therefore, the bonding structure between the battery component part 20 and the bare cell 100 is substantially the same. Hereinafter, the embodiments according to FIGS. 4 and 5 will be explained. The only difference between the embodiment according to FIG. 3 and those according to FIGS. 4 and 5 is that the male mechanical coupling portions (not shown) of the battery component part are mechanically engaged with the female mechanical coupling portions 50 of the bare cell 100 and welded so as to reduce the electrical resistance and to increase the stability of electric connection. Because the electric connections in these embodiments are further stabilized by welding in addition to mechanical coupling, an additional gold plating layer or silver paste as an electric resistance-reducing means is not necessary.

In one exemplary embodiment, welding at the point of mechanical coupling is performed by a laser welding method. Specifically, when the mechanical coupling portions are embedded in a plastic molding, a laser spot welding method applying local heating may be used because a resistance welding method tends to cause deformation of the plastic molding 24. Also, when the mechanical coupling portions are formed from a conductor such as aluminum, a laser beam welding method has to be used rather than a resistance welding method.

Additionally, when the mechanical coupling portions are welded, for example, at weld points 253a, 253b, 263, through a narrow gap 200 between the battery component part 20 and the bare cell 100 as shown in FIG. 4, a laser spot welding method may be because of the convenience of welding using a very small, and therefore more accurate, laser beam. Although, as shown in an enlarged state in FIG. 5, a groove 241 in the plastic molding 24 through which laser beam can be irradiated can be formed, it is not necessary to form such a large groove 241 when a laser beam welding method is used.

As shown in FIG. 4, in order to create the gap 200 for welding, the male mechanical coupling portions 25, 27 (FIG. 3) of the battery component part 20 protrude from the coupling surface of the battery component part. However, if the male mechanical coupling portions excessively protrude from the bonding surface, the resistance to bending between the battery component part 20 and the bare cell 100 may be weakened. Therefore, the male mechanical coupling portions preferably protrude from the coupling surface to create the minimum space for welding. As shown in FIG. 4, the welding may also be performed at the negative terminal 130 of the bare cell 100 and the negative electrode connection part 26 of the battery component part.

Because welding as described above is performed not for providing mechanical strength, but rather for providing stability in electric connections and reducing electrical resistance, it is not necessary to weld to a great depth over a wide area. However, mechanical bonding strength at mechanical coupling portions may be further reinforced by spot welding.

In order to form a groove 241 of the battery component part by using a plastic molding as shown in FIG. 5, a mold for plastic molding may be formed to have a groove. The groove 241 may be formed on the front surface only or both on the front surface and the rear surface. When the laser beam is irradiated through the groove for a predetermined time, the exterior surface of the female mechanical coupling portion 50a, 50b is partially molten and the exterior surface of the male mechanical coupling portion, which is in contact with the interior surface of the female mechanical coupling portion, is also molten due to heat conduction. Therefore, spot welding at weld points 253a, 253b may be accomplished.

When assembled plastic members are used instead of the plastic molding, the plastic members may be formed to have male mechanical coupling portions protruding as shown in FIG. 4. Otherwise, a groove may be formed in the plastic members constituting a lower part of the battery component part. Although the terminals functioning as mechanical coupling portions are also welded in the embodiments according to FIGS. 4 and 5, in one exemplary embodiment, only the mechanical coupling portions functioning as electric connection terminals are welded, since the increasing the number of welding points results in the increase of labor and time needed for welding.

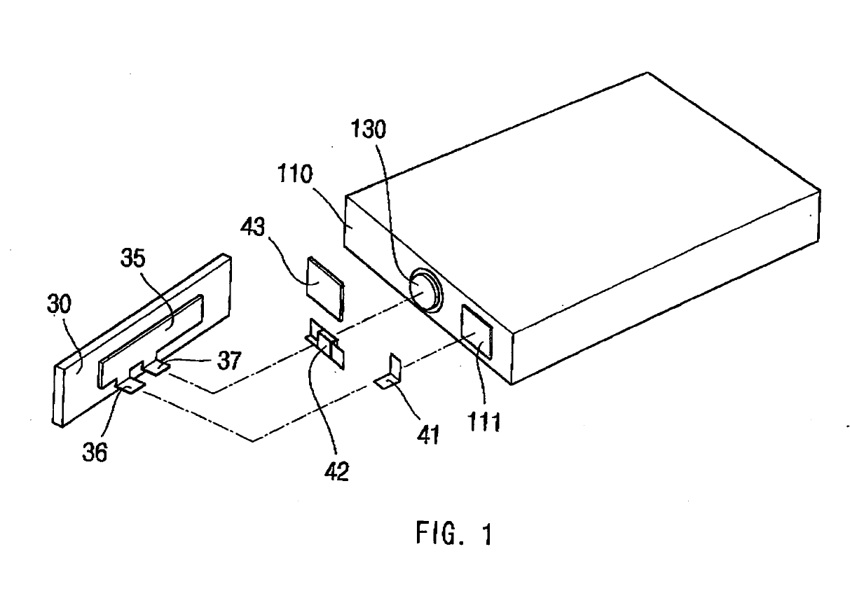

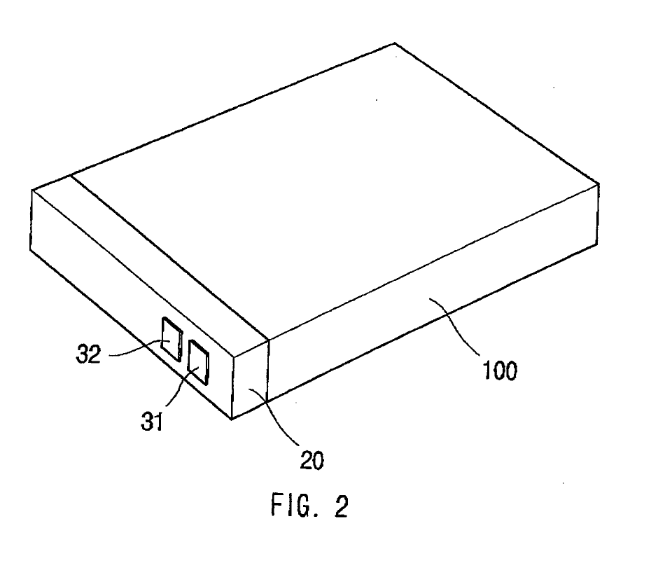

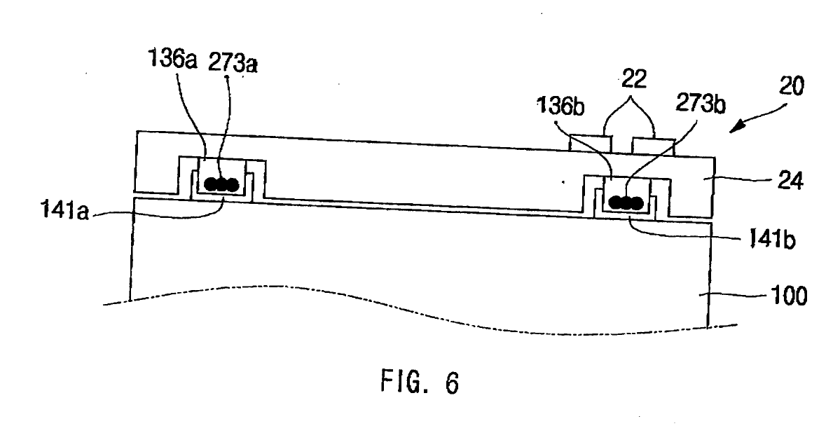

As shown in FIG. 6, lead plates 136a, 136b, 141a, 141b similar to electric terminals as shown in FIG. 1 are used as coupling portions between the battery component part 20 and the bare cell 100. The difference of the embodiment according to FIG. 6 compared to the embodiment according to FIG. 1 is that the means for coupling the protective circuit board with the bare cell is not a plastic molding. More specifically, the protective circuit board as a safety device is incorporated into the battery component part 20 by the plastic molding 24 and then is coupled with the bare cell 100. Additionally, in order to couple the battery component part 20 with the bare cell 100, lead plates 136, 141 are welded together. In order to facilitate welding, the plastic molding is equipped with a groove, through which substantially all of the lead plates 136, 141 is exposed to the exterior even when the bare cell 100 is coupled with the battery component part 20. Due to the presence of the groove, a suitable welding method may be applied depending on the materials contained in the lead plates 136, 141. For example, a resistance welding method may be used in addition to a laser welding method. In this case, however, welding of the lead plates 136, 141 between the battery component part 20 and the bare cell 100 must be sufficient to maintain the mechanical strength of the bond formed between the battery component part and the bare cell. Therefore, a spot welding method for reducing electrical resistance by transforming contact resistance into welding resistance as shown in FIG. 4 or 5 may not be suitable. Additionally, it may be necessary to make more welding points 273a, 273b with a greater depth and to use a thick lead plate having a sufficient mechanical strength. In order to increase the mechanical strength of the welding point, the groove for exposing the coupling portions according to the above-described embodiment may be in communication with both surfaces of the battery. More particularly, the groove preferably causes both lead plates 136a, 136b, 141a, 141b of a bonding point to be exposed to the exterior so that both sides of the bonding point can be welded.

The structure and configuration of coupling portions according to embodiments of the present invention are not limited to the embodiment as shown in FIG. 3. Also, the structure for facilitating welding is not limited to the embodiments as shown in FIGS. 4 to 6.

It should be considered that secondary batteries generally constitute different materials, shapes, sizes, etc., depending on their production companies and product models. Since a suitable design of a safety device is determined by such factors, the selection of a safety device for a battery component part depends on the characteristics of a bare cell to be coupled with the battery component part as long as general characteristics of secondary batteries are not standardized.

When a battery component part is recycled, the battery component part has an increased possibility for being undesirably coupled with an unsuitable bare cell, and thus, a structure for preventing such undesirable couplings is desirable. Such a structure may be obtained by varying the position, size and number of mechanical coupling portions in a bare cell and in a battery component part according to the capacity and characteristics of the bare cell, e.g., by forming a “recognition structure.” Alternatively, the recognition structure may be created by forming both bonding surfaces of the battery component part and the bare cell to have a concave portion and a convex portion, respectively, complementary to each other.

According to the recognition structure differing depending on the characteristics of bare cells, it is possible to prevent dangers in use that may be caused by using an unsuitable safety device during charge/discharge of the bare cell. Even though several bare cells are available from different companies and as different product models, one battery component part may be shared among the bare cells if the bare cells have the same characteristics over a certain range, thereby increasing interchangeability.

According to embodiments of the present invention, it is possible to overcome the problems of the prior art, such problems including not protecting the circumference of a safety valve during the formation of a plastic molding, and not uniformly filling the gap between a safety device and a bare cell with a resin for plastic molding.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A secondary battery comprising:
a bare cell including an electrode assembly having a negative electrode, separators, and a positive electrode, a container-type can for housing the electrode assembly and an electrolyte, and a cap assembly for closing the can; and
a safety device electrically coupled to an exterior surface of the bare cell, wherein the safety device is incorporated into a battery component part;
wherein an exterior surface of the bare cell and an exterior surface of the battery component part has a coupling portion for coupling the exterior surface of the bare cell to the exterior surface of the battery component part; and
wherein, the exterior surface of the bare cell and the exterior surface of the battery component part further includes a supplementary element for supplementing the coupling between both coupling portions.

2. A secondary battery as claimed in claim 1, wherein the battery component part is formed by encapsulating at least a part of an exterior surface of the safety device with a plastic molding.

3. A secondary battery as claimed in claim 1, wherein the battery component part is formed by mounting the safety device in an assembled casing.

4. A secondary battery as claimed in claim 1, wherein at least a part of the coupling portions functions as an electric connection terminal between the safety device and the bare cell.

5. A secondary battery as claimed in claim 4, wherein the supplementary element is a plating layer on a contact surface formed by engaging the coupling portions.

6. A secondary battery as claimed in claim 1, wherein the supplementary element is a paste coating layer applied on a contact surface formed by engaging the coupling portions.

7. A secondary battery as claimed in claim 1, wherein the supplementary element is a weld formed after the coupling portions are engaged.

8. A secondary battery as claimed in claim 1, wherein the coupling portions have a recognition structure obtained by varying at least one of the group consisting of the position, size and number of the coupling portions, depending on characteristics of the is bare cell.

9. A secondary battery as claimed in claim 1, wherein the supplementary element is used for reinforcing the bonding between the coupling portions, and is a groove formed on the battery component part, through which the coupling portions can be exposed to the exterior, while the coupling portions of the battery component part are in contact with those of the bare cell.

10. A secondary battery as claimed in claim 9, wherein the coupling portions are lead plates formed on the bonding surfaces of the battery component part and the bare cell.

11. A secondary battery as claimed in claim 9, wherein the coupling portions are a female receiver portion and a male insertion portion formed on the bonding surfaces of the battery component part and the bare cell.

12. A secondary battery as claimed in claim 1, wherein the supplementary element is provided by forming the coupling portions of the battery component part to protrude from the bonding surface so that a gap is formed between the battery component part and the bare cell and the coupling portions are exposed to the exterior 1o through the gap, while the coupling portions of the battery component part are engaged with those of the bare cell.
